(19) United States
(12) Patent Application Publication
(10) Pub. No.: US 2008/0237292 A1
(43) Pub. Date: Oct. 2, 2008

(54) APPARATUS FOR REPLACING A KNOTTER IN A TAG FASTENER

(76) Inventor: Duk-Hee Lee, Seoul (KR)

Correspondence Address: KING & SCHICKLI, PLLC, 247 NORTH BROADWAY, LEXINGTON, KY, 40507, US

(21) Appl. No.: 12/055,638

(22) Filed: Mar. 26, 2008

(30) Foreign Application Priority Data
Mar. 29, 2007 (KR) 10-2007-0030602

(51) Int. Cl. B65C 7/00

(52) U.S. Cl. 227/67; 227/156

(57) ABSTRACT

The present invention relates to an apparatus for replacing a knotter in a tag fastener, wherein the knotter is mounted on a separate base plate and the hub of the pinion of the knotter is inserted vertically from the bottom of a side plate of the tag fastener body. The pinion protruding onto the outside of the base plate is mounted onto a side of the body by the base plate and engaged with the driving gear arranged on the outside of the body of the tag fastener. A tag is fastened by the tag fastener while the knotter, working in conjunction with the mechanism in the body, knots a looped thread and cuts the knotted loop. The knotter can be separated easily from the body of the tag fastener for repair or replacement without disassembling the body of the tag fastener.

### TECHNICAL FIELD

The present invention relates to an apparatus for replacing a knotter in a tag fastener.

### BACKGROUND OF THE INVENTION

There have been tagging apparatuses such as a tag gun that fastens a tag on a product with a plastic tag pin and a tag fastener by knotting a looped thread. The most important of the various devices in a tag fastener using a thread is a knotter that knots a looped thread.

The prior arts of tag fasteners and knotters have been disclosed in a published Japanese Utility Model Gazette Showa 57-41124 (published 9 Sep. 1982), published Japanese Patent Gazette Showa 57-44533 (published 12 Sep. 1982), published Japanese Patent Gazette Showa 57-48457 (published 16 Oct. 1982), published Japanese Patent Gazelte Showa 59-5315 (published 3 Feb. 1984), published Japanese Utility Model Gazelle Showa 63-44332 (published 17 Nov. 1988), published Japanese Utility Model Gazette Showa 63-44333 (published 17 Nov. 1986), published Japanese Patent Gazette Showa 63-294337 (published 1 Dec. 1989), and published Japanese Patent Gazette Heisei 1-267142 (published 25 Oct. 1989).

Main mechanical features of a tag fastener are as follows. As seen in the lower drawing in FIG. 1, the needle (N) of a tag fastener (F) pierces through the product and the tag; and when the driving lever (V) of the body of the tag fastener is pulled, a thread is supplied to the needle (N) through a groove in the needle (N) via a thread supply rod (P) that works as part of the tag fastener; the thread that went through the tag is hooked by a hook (H) and drawn into the body (f); the thread thus drawn into the body is taken to the knotter (A) by a thread contactor (D); a beak-shaped knotter (A), rotating one full round, knots the looped thread, and the cutters of the knotter (A) cut the thread while a thread holder (J) holds the thread from the thread supply rod (P), thereby completing the process of fastening a tag with a knotted and looped thread.

In reality, the tag fastener for fastening a tag with a thread is not popular among the users because the tag fastener has too complex a mechanism as compared with its simple use as a tag fastener. Besides, its production cost is high, and as it has so many component parts, it often goes out of order causing inconvenience for the use of the general public.

In particular, the beak-shaped knotter consists of static beaks, thread cutters, a cam lever operating the thread cutters, and a fixed ring-shaped cam operating the cam lever. The knotter is of a small size and consists of a very complex mechanism requiring high precision and sophistication.

In a conventional tag fastener, as in the above-noted cited references, a knotter is assembled with the other components between the side plates of the body. Therefore, the knotter is not visible from the outside of the tag fastener. As the knotter has a complex function of knotting the thread and cutting the knotted thread, it is more liable to wear and trouble than the other components are.

In other words, as a knotter cuts the threads so frequently with its shearing operation, the blades are very liable to wear. If the worn-out blades turn incapable of cutting the threads, the threads released by the repetitive operation of the thread supply rod inside the body entangle onto the gear components inside the body, disturbing the operation of the tag fastener. Whenever this happens, the body must be disassembled for repair. As the repair work cannot be done by an ordinary user but rather requires a skilled mechanic, it is very inconvenient and troublesome. Because of this problem, it was difficult to put the thread-using tag fastener into practical use. As a result, even today, a tag gun, which fastens a tag using a tag pin, is in general use.

However, threads are available more easily than plastic tag pins, and because the unit price of a thread is cheaper than that of a plastic tag pin, it is much more advantageous economically to fasten a tag with a thread than with a plastic tag pin. For this reason, efforts are being made to improve a tag fastener.

### SUMMARY OF THE INVENTION

The object of the present invention is to provide an apparatus for replacing a knotter in a tag fastener that fastens a tag with a thread, by mounting a knotter, which is one of the most important key components that is liable to wear and trouble, on a separate base plate, by forming an inserting groove on a side plate of the body of the tag fastener so as to insert a knotter therein by providing a gear for driving the knotter on the outside of the body, and by mounting the base plate of the knotter onto the body in such a way as to be separable from the body so that if the blades of the cutters of the knotter become blunt, the knotter may be easily separated from the body for repair and replacement.

Another object of the present invention is to construct the knotter, the most important component in a tag fastener, in such a way as to be easily separable from the body, eliminating the inconvenience of disassembling the body of the tag fastener for repairing the knotter and thereby to enhance the convenience and efficiency of a tag fastener in use facilitating practical use of a tag fastener.

The present invention provides a tag fastener with a replaceable knotter. In general, a knotter comprises a rotator that is rotated by a pinion, a pair of static beaks arranged in the rotator, thread cutters provided in between the static beaks, a cam lever that makes the thread cutters perform shearing operations against the static beaks, and a ring-shaped cam that operates the cam lever. The knotter of this construction is known in a number of cited references. The present invention is not an invention of a knotter but an invention of a new apparatus for replacing a knotter.

In other words, a knotter is mounted on a base plate in such a way that the pinion of the knotter assembly protrudes out of the base plate and an inserting groove is formed vertically at the bottom of a side plate of the body into which the hub of the pinion is inserted so that the pinion and the driving gear arranged outside of the body may engage with each other. With this construction, the knotter is separable from the body of the tag fastener.

In the present invention, as both the pinion and the driving gear are arranged outside of the body, it is easy to construct the apparatus for replacing the knotter and to match the point dots of the rotating angle of the pinion of the knotter and the driving gear. If the rotating angle of the knotter deviates from the action angle, the knotter cannot work in conjunction with the other components in the body, failing to perform its knotting work. Therefore, it is important to match the point dots of the rotating angles of the driving gear and the pinion. The ratio of the diameters between the pinion of the knotter and the driving gear is 1:2. When the driving gear rotates a ½ round (180 degrees), the pinion rotates one full round (360 degrees) by which the knotter knots a looped thread.

If the knotter is inserted into the inserting groove of the body of the tag fastener by placing the base plate of the knotter against the body and mounting it with mounting bolts, the knotter is placed in the proper position in the body according to the design, and the pinion and the driving gear are engaged on the outside of the base plate and on the outside of the side plate respectively. At this time, the position at which the pinion and the driving gear engage with each other is in the lower diagonal direction of 30-45 degrees against the horizontal baseline of the driving gear. In this direction, the pinion, moving on a vertical track into the inserting groove of the body, reaches the best position of engaging its teeth with the teeth of the driving gear having a diameter twice as long as that of the pinion.

Engaging the pinion with the driving gear at the latter's bottom portion makes it difficult to secure a space for mounting the base plate of the knotter. Engaging the pinion with the driving gear at the latter's horizontal side makes it difficult to secure the space for the lateral movement of the knotter because of the other elements arranged in the body. However, the bottom portion of the body has a space set aside for releasing waste threads, therefore, it is most convenient to mount and dismount the knotter through the bottom portion of the body.

After the knotter is mounted onto the body via its base plate, the knotter plays a role of knotting the looped thread of the tag, cuffing the thread and fastening the tag with a thread whenever a tag is fastened by the intermittent driving of the driving mechanism.

According to the present invention, as the knotter is mounted on its base plate independently and mounted onto the body of the tag fastener, if the knotter goes out of order or the blades of the cutters turn blunt, the knotter can be easily dismounted from the body for repair or replacement without undergoing the inconvenience of disassembling the body.

Therefore, the tag fastener can be used more conveniently and efficiently, increasing practicality in use.

### BRIEF DESCRIPTION OF THE DRAWINGS

FIG. 1 is side views of a tag fastener in the present invention from which a side plate is separated from the body.

FIG. 2 is a perspective view of the knotter mounted on a base plate.

FIG. 3 is a side view of the knotter mounted on a base plate.

FIG. 4 is a side view of the knotter mounted on a base plate and separated from the body.

FIG. 5 is a side view of the knotter mounted on a base plate and mounted on a side plate of the body.

FIG. 6 is a bottom sectional view showing the knotter mounted on a side plate of the body.

### NUMERALS USED IN THE DRAWINGS

1: base plate, 2: hub, 3: inserting groove, A: knotter, B: bottom plate,

C: ring-shaped cam, D: thread contactor, F: tag fastener, f: body, fa: a side plate, G1: pinion, G2: driving gear, H: hook,

J: thread holder, L: cam lever, M: thread cutters, N: needle,

P: thread supply rod, R: rotator S: static beak, V: driving lever,

s: mounting bolt, e, e′: matching line, d, d′: point dot

### DETAILED DESCRIPTION OF THE INVENTION

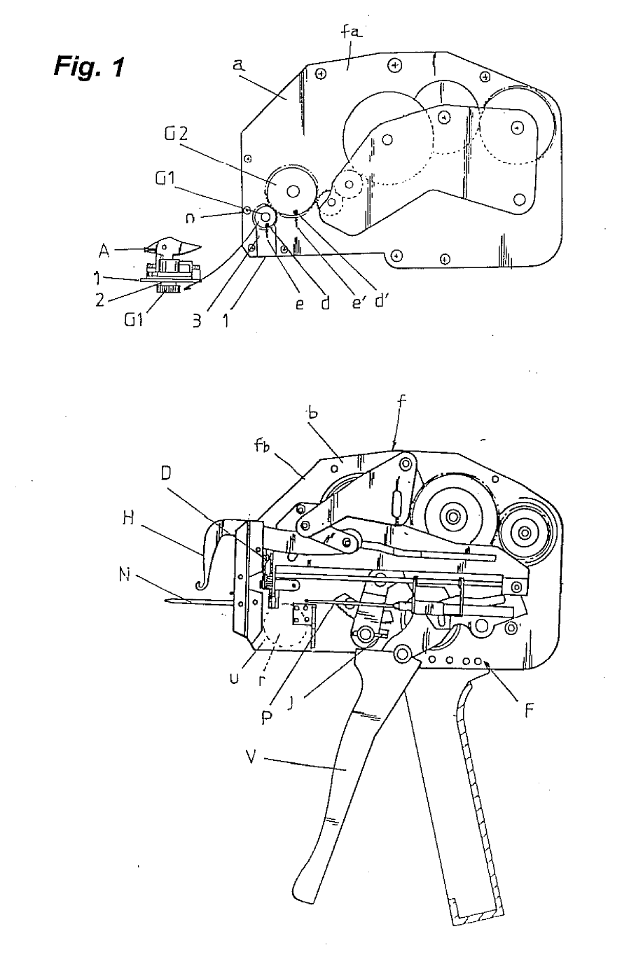

FIG. 1 is a view of the tag fastener (F) for fastening a tag with a thread from which a side plate (fa) has been separated from the body (f) of the tag fastener (F) according to the present invention. The upper drawing in FIG. 1 is a side view of a side plate of the body (f) onto which the apparatus of the knotter in the present invention is mounted. The lower drawing in FIG. 1 is a side view of the interior space of the other side plate (fb) of the body showing the positions of the known mechanism of a tag fastener and the space (r) in which the knotter (A) is located.

In the present invention, a knotter (A) is provided in the body (f) of a tag fastener (F) in which the knotter comprises in the form of an assembly a rotator (R) mounted on a bottom plate (B) and rotating by a pinion (G1), a pair of static beaks (S) arranged in the rotator, thread cutters (M) with sharp blades provided in between the static beaks (S), and a cam lever (L) that makes the thread cutters shear threads with which the tag fastener fastens a tag by looping and knotting a thread.

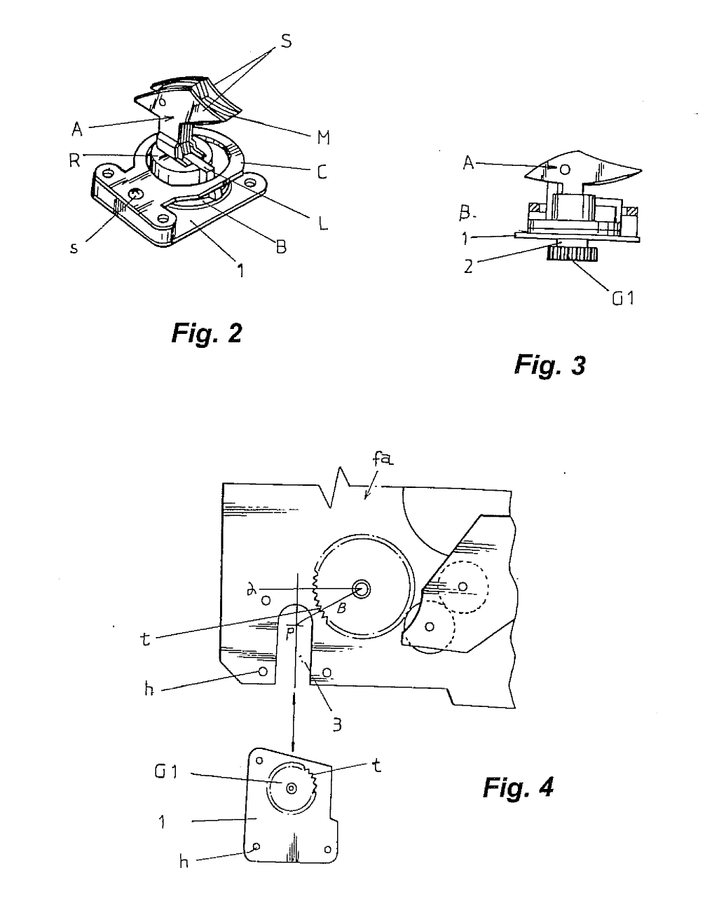

As shown in FIG. 2 and FIG. 3, the knotter (A) in the form of an assembly is mounted on a base plate (1) in such a way that the pinion (G1) protrudes outside the base plate (1), and the bottom plate (B) and the base plate (1) of the knotter (A) are mounted integrally onto each other by mounting bolts (s) or rivets. At this time, care should be taken that the point dot (d) of the pinion (G1) and the matching line (e) of the base plate (1) are marked so that the knotter (A) in the form of a beak may be positioned in a desired rotating angle. Mounting the knotter (A) onto the body (f) while the point dot (d) of the pinion (G1) and the matching line (e) of the base plate (1) are not matched results in the deviation of the rotating angle of the knotter (A) making it impossible for the knotter to knot the looped thread, as the knotter cannot hold the thread even if the thread contactor (D) which operates in synchronization with the knotter supplies the thread to the knotter.

As shown in FIG. 4, on a side plate of the body (f) of the tag fastener (F) where the knotter is to be located, an inserting groove (3) of a certain length is formed into which the hub (2) of the pinion (G1) is to be inserted vertically from the bottom, and the driving gear (G2) that drives the pinion (G1), which used to be arranged inside the body in conventional arts, is arranged on the outside of the side plate (fa) in such a way as to work in conjunction with the pinion (G1). At this time, care should be taken that the point dot (d′) of the driving gear (G2) and the matching line (e′) of the side plate (fa) are marked so that the starting rotating angle of the driving gear (G2) that drives the pinion (G1) is set precisely. Once the rotating angle of the driving gear is set, the rotating angle of the driving gear is maintained steadily without alteration because it is interconnected with the rest of the mechanism. When the driving gear is assembled, if the point dot (d′) of the driving gear (G2) and the matching line (e′) of the side plate (fa) do not match, the rotating angle of the driving gear (G2) which rotates a ½ round and stops and the rotating angle of the pinion (G1) which rotates one full round whenever the lever of the body is pulled cannot be synchronized, resulting in an increase or a decrease in the rotating angle of the pinion, making it impossible to perform the knotting operation.

The ratio between the diameters of the pinion (G1) of the knotter (A) and the driving gear (G2) is 1:2. In a preferred embodiment, the diameter of the pinion was 10 mm with 20 teeth, and the diameter of the driving gear (G2) was 20 mm with 40 teeth. As the driving lever of the tag fastener is pulled once, the driving gear (G2) rotates a ½ round and the pinion (G1) rotates one full round, enabling the knotter (A) to knot. On the side plate around the inserting groove (3) of the body (f) and on the base plate (1) of the knotter, there are formed a plurality of holes (h) at set positions for mounting the mounting bolts (n). The set positions are for the set position of the knotter (A), and under this condition, the position of the driving gear (G2) is set by design so that the teeth of the pinion (G1) may engage with the teeth of the driving gear (G2).

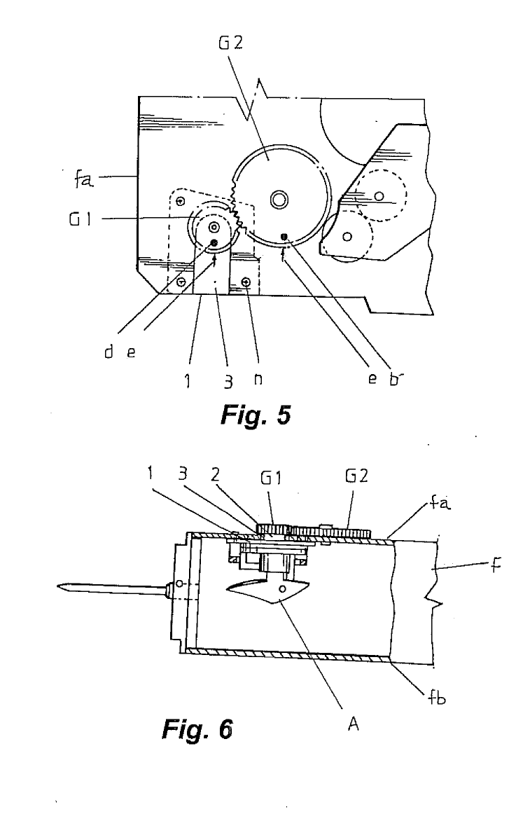

Therefore, as shown in FIG. 5 and FIG. 6, if the hub (2) of the pinion (G1) is press-inserted into the inserting groove (3) formed on the side plate (fa) of the body after placing the base plate (1) of the knotter (A) against the inner side of the side plate (fa) of the body (f) of the tag fastener (F), the base plate reaches and stops at a point where the teeth of the pinion (G1) engage with the teeth of the driving gear (G2) on the outside of the side plate (fa). In other words, the said press-inserting of the hub (2) of the pinion is carried on until the base plate (1) of the knotter (A) comes to a stop at the position at which the teeth (t) of the pinion (G1) and the driving gear (G2) engage on the outside of the side plate. The position at which the pinion (G1) and the driving gear (G2) engage with each other is in the lower diagonal direction of 30-45 degrees (β) against the horizontal baseline (α) of the driving gear (G2). To this direction, the pinion (G1), moving on the track along the inserting groove (3) of the body (f), reaches the best position of engaging its teeth (t) with the teeth (t) of the driving gear (G2) without deviating from the set rotating angle. The position of engagement between the pinion and the driving gear is not variable once it is set by design. Because the entire mechanism of the tag fastener operates synchronistically by the pulling of the driving lever, it is impossible to alter only the rotating angles of the pinion and the driving gear apart from the other components. If the mounting holes of the base plate (1) and the side plate (fa) are matched and the mounting bolts (n) are fastened, the rotating axis of the pinion (G1) is positioned at the p point (shown in FIG. 4) of the inserting groove (3). Therefore, the knotter (A) is fixed in the space of the set position marked by the dotted line (r) in the lower drawing in FIG. 1. At the same time, the teeth (t) of the pinion (G1) and the teeth (t) of the driving gear of the body (f) engage with each other precisely at a set rotating angle, thereby composing the apparatus for replacing a knotter in the present invention.

The present invention is the same as the conventional art as far as the function of fastening a tag is concerned. As seen in the conventional art, the process of fastening a tag is as follows. The needle (N) of the tag fastener (F) pierces through the product and the tag; and by pulling the driving lever (V), the thread supply rod (P) supplies the thread through the groove of the needle (N). Then the thread of the needle that has pierced through the tag is drawn into the body (f) by the hook (H); the thread contactor (D) catches the thread drawn in and takes it to the knotter (A); the knotter (A) rotates one full round by the conjunctive operation of the driving gear (G2) and the pinion (G1) and knots the looped thread; at the same time, while the thread holder (J) is holding the thread from the thread supply rod (P), the static beaks and the thread cutters working together shear off the residual threads from the knotted loop and fasten the tag,

As the present invention is not an invention of a knotter, further details of the explanation on the operation of a knotter is not given.

According to the present invention, a knotter mounted on a base plate (1) is separably mounted onto a side plate (fa) of the body (f) of the tag fastener. Therefore, although the function unique to a tag fastener remains the same, the knotter (A) using the apparatus in the present invention can be separated from the side plate (fa) of the body (f) for repair or replacement without disassembling the body of the tag fastener if the blades of the cutters (static beaks and the thread cutters) become dull and fail to cut threads properly. In other words, the knotter can be easily dismounted from the body (f) by releasing the mounting bolts and removing the base plate (1) from the bottom portion of the body (f) through the inserting groove (3) from the space of the waste thread release outlet (U) without being disturbed by the other components. After being repaired or replaced, the knotter (A) is remounted onto the body (f) of the tag fastener (F) by placing the base plate (1) at the side plate (fa) of the body and pressing in so that the hub (2) of the pinion (G1) of the knotter (A) may be inserted into the inserting groove, then immediately before the teeth (t) of the pinion (G1) and the teeth of the driving gear (G2) engage with each other, the point dot (d) of the pinion (G1) and the point dot (d′) of the driving gear (G2) are matched with their respective matching lines (e, e′), then adjusting the position of the knotter so that said teeth of the pinion and the driving gear are precisely engaged with each other, the base plate (1) of the knotter (A) is mounted integrally onto the side plate (fa) of the body (f) by means of bolts (n) and holes (h).

In the present invention, as the pinion (G1) of the knotter (A) and the driving gear (G2) are arranged on the outside of the body (f), the space in which the pinion and the driving gear used to occupy inside the body holding many components is no longer necessary, thereby affording the tag fastener more room for designing and arranging its components inside the body. Furthermore, as the user can visually ascertain whether the point dots (d, d′) of the pinion (G1) and the driving gear (G2) match their respective matching lines (e, e′), the independently structured knotter can be mounted onto the tag fastener in such a way that the knotter can operate precisely in synchronization with the other components of the tag fastener.

Besides, as the composition of the apparatus for replacing the knotter is very simple and its production so easy, the knotter can be replaced easily without impairing the unique function of the knotter. Therefore, if the knotter goes out of order or its thread cutting function deteriorates due to wears to the cutter blades, the entire tag fastener need not be thrown away, as was the practice previously, but the knotter can be repaired and replaced easily. As a result, convenience and efficiency of the tag fastener in use is enhanced, increasing the practicality in use of the tag fastener using a thread.

In the present invention of a tag fastener for fastening a tag by knotting a looped thread, a beak-shaped knotter having the function of knotting looped threads and cutting knotted threads is mounted on a base plate and separably mounted onto a side plate of the body of the tag fastener with the pinion and the driving gear arranged on the outside of the base plate and the body respectively and operating in synchronization with the other components in the tag fastener, making the apparatus for replacing the knotter very simple and its production easy.

The construction of the apparatus for replacing the knotter is simple and the knotter can be mounted onto and dismounted from the body so easily that if the blades of the cutters of the knotter turn blunt, the knotter can be easily repaired or replaced for repetitive use.

Besides, the replaceability of the knotter enhances the convenience and efficiency of the tag fastener in use enhancing the practicality in using the tag fastener.

What is claimed is:

1. An apparatus for replacing a knotter in a tag fastener, comprising:
a tag fastener body; and
a knotter mounted integrally on a base plate;
wherein the knotter and base plate assembly is removably mountable to the tag fastener body.

2. An apparatus for replacing a knotter in a tag fastener as claimed in claim 1, wherein the knotter comprises:
a rotator mounted on a rotatable bottom plate for rotation by a pinion;
a pair of static beaks arranged in said rotator;
bladed thread cutters positioned between said static beaks;
a cam lever for making said thread cutters shear threads; and
a ring-shaped cam for operating said cam lever at a set angle.

3. An apparatus for replacing a knotter in a tag fastener as claimed in claim 1, wherein the base plate is mounted in an inserting groove formed in a side plate of the tag fastener body.

4. An apparatus for replacing a knotter in a tag fastener as claimed in claim 3, further including a toothed driving gear positioned on the side plate.

5. An apparatus for replacing a knotter in a tag fastener as claimed in claim 3, wherein a toothed knotter pinion protrudes from the base plate and engages the driving gear.

6. An apparatus for replacing a knotter in a tag fastener as claimed in claim 5, wherein the knotter is mounted onto the tag fastener body side plate by:
aligning a knotter pinion marker with a corresponding base plate marker; and
aligning a driving gear marker with a corresponding side plate marker;
whereby the knotter may be removably mounted onto the tag fastener body side plate in a predetermined operating position.

7. An apparatus for replacing a knotter in a tag fastener as claimed in claim 6, wherein said knotter pinion teeth and said driving gear teeth engage on a plane oriented at an included angle of from about 30 to about 45 degrees from a horizontal plane.
